(19) United States
(12) Patent Application Publication
(10) Pub. No.: US 2025/0135382 A1
(43) Pub. Date: May 1, 2025

(54) FLUID COOLING/FILTERING ASSEMBLY

(71) Applicant: ARBURG GMBH + CO KG, Loßburg (DE)

(72) Inventor: Rainer BLETSCHER, Baiersbronn (DE)

(21) Appl. No.: 18/836,164

(22) PCT Filed: Feb. 8, 2023
(86) PCT No.: PCT/EP2023/053058

§ 371 Date: Aug. 6, 2024

(30) Foreign Application Priority Data
Feb. 9, 2022 (DE) 10 2022 103 070.9

(51) Int. Cl. B01D 35/26; B01D 35/02; B01D 37/04; B29C 45/83; F15B 21/041; F15B 21/0423; F16N 39/02; F16N 39/06

(52) U.S. Cl. CPC B01D 35/26; B01D 35/02; B01D 37/045; B29C 45/83; F15B 21/041; F15B 21/0423; F16N 39/02; F16N 39/06

(57) ABSTRACT

A fluid cooling/filtering assembly, having a first pump, which is designed to pump a fluid out of a first container into a circuit, and a second pump, which is designed to pump the fluid into the first container via at least one cooling and/or filtering device, where the second container is separate from the first container and collects the fluid from the circuit and from which the second pump pumps the fluid into the first container via the cooling and/or filtering device and where the second pump can be controlled at least on the basis of the fluid collected in the second container from the circuit and on the basis of the fill level of the fluid in the first and/or second container.

### REFERENCE TO RELATED APPLICATIONS

The present application relates to and claims the priority from German patent application 10 2022 103 070.9, filed on 9 Feb. 2022, the disclosure of which is hereby expressly, in its entirety, made part of the subject matter of the present application.

### TECHNICAL FIELD

The disclosure relates to a fluid cooling/filtering arrangement for a machine for processing plastics and other plasticizable materials, to a method for filtering and cooling a fluid for a machine for processing plasticizable materials, and to a machine for processing plastics and other plasticizable materials, in particular an injection molding machine.

### BACKGROUND

For the purpose of producing precise moldings, for example of plastics, machines for processing plastics and other plasticizable materials, in particular injection molding machines, are used, which typically have a plurality of components, such as an injection unit and a closing unit or other hydraulic components, which have to be cooled and/or lubricated using a fluid. In this context, the fluid should not exceed a certain temperature, since otherwise the cooling action of the fluid may be insufficient for the corresponding components or consuming devices, and the components may be damaged, which impairs the molding production process. Further, it is necessary for the fluid to have a certain purity so that the cooled components and/or their fluid circuit are not clogged by impure or dirty fluid, likewise resulting in an insufficient cooling action or leading to failure of the components.

Known from the prior art, for the purpose of cooling and filtering a fluid such as oil, are conventional concepts such as back filtration, in which the fluid that flows back from the consuming devices is guided back into the tank by way of a section for filtering/cooling. Here, the low costs of back filtration are advantageous, but disadvantageously, the components in the section for filtering/cooling have to be configured to withstand the high peak loads.

An alternative is bypass filtration, in which the fluid of the consuming devices is guided back into the tank, and a continuous volumetric flow is removed from the tank by an additional pump and guided back into the tank by way of a section for filtering/cooling. Advantageously, the components in the section for filtering/cooling may be configured to be smaller as a result of the quantity that is continuously supplied. Disadvantageously, in the tank the dirty fluid that is enriched with air mixes with the already filtered and cooled fluid, such that the efficiency suffers from the mixing.

DE 42 03 062 C1, for example, discloses a hydraulic installation with a main and a secondary flow circuit and bypass filtration, comprising a liquid container with an intermediate wall for limited screening of the liquid streams coming into and out of the liquid container. The conveying conduit to the secondary filter pump in the liquid container is arranged directly next to the incoming leaked liquid conduits, wherein this region is partially screened from the rest of the liquid container. It is disadvantageous with this solution that there is mixing of returning fluid and already filtered and cooled fluid. Although the liquid container is partially screened, because of the arrangement of the components there is no clear separation of the return and the intake region. Because there is no fluid conduit with a calming zone, stratification problems occur in the liquid container. Likewise disadvantageous with this solution is the fact that the cooled and filtered fluid is drawn in again immediately, with the result that the fluid does not have time to be “calmed down” and to be degassed of any dissolved air by way of a calming section.

EP 2 840 239 B1 discloses a fluid cooling/filtering arrangement having a pump motor that is controlled by closed-loop control. The speed of the pump motor may be controlled depending on a load condition of a machine operated by the fluid, wherein a sensor device measures the fluid pressure and the fluid temperature and a processing unit determines the load condition from a measurement value.

DE 39 31 699 A1 discloses a method for cold-starting mobile driven machines having an internal combustion engine. The required viscosity of the oil for the driven machine is to be obtained by pre-heating the oil. A diesel engine drives a feed circuit pump that draws hydraulic oil in from the dirty side of a hydraulic tank. The hydraulic oil passes by way of a five-way valve to reach the oil filter, and from there reaches the clean side of the hydraulic tank. From the clean side of the hydraulic tank, pumps driven by the diesel engine feed the hydraulic oil back to the dirty side of the hydraulic tank by way of return conduits. Here too, likewise it is again disadvantageous that the fluid is drawn in again immediately, with the result that the fluid does not have time to be “calmed down” and degassed. The tank is under a pre-established pressure, and the clean and the dirty side are connected by way of an overpressure valve, with the result that no calming section is available to the oil because of the permanently positive pressure.

DE 101 51 058 A1 discloses a liquid circuit having a liquid storage tank, a liquid pump and a liquid filter. The liquid circuit is under a pre-established pressure in its outward section downstream of the liquid pump, and is not pressurized in its return line. The liquid filter is arranged in the unpressurized return line of the liquid circuit, as the main flow filter.

### BRIEF SUMMARY

The disclosure is to enable advantageously effective and reliable cooling for a machine for processing plastics and plasticizable materials, in particular an injection molding machine.

The fluid cooling/filtering arrangement for a machine for processing plastics and plasticizable materials, in particular an injection molding machine, comprises a first pump, for example a variable pump of predeterminable conveying volume, which is configured for pumping at least one fluid, for example oil, out of a first container, for example a tank, an oil tank, into a circuit, for example a working circuit. The circuit supplies fluid to at least one consuming device, such as a machine for processing plastics and plasticizable materials, in particular an injection molding machine. The fluid is used to cool and/or lubricate the consuming devices. Likewise, the fluid may be utilized for energy transfer, since consuming devices for example are also moved using the fluid. Generally, the circuit may have various consuming devices, in particular an injection molding machine, parts or components of the injection molding machine, such as a closing unit, an injection molding unit, and corresponding peripherals such as a robot.

Further, the fluid cooling/filtering arrangement has a second pump, for example a variable pump of predeterminable conveying volume, which is configured for pumping the fluid into the first container by way of at least one cooling and/or filtering device. In order to advantageously enable effective and reliable cooling, at least one second container, separated from the first container, for example a tank, an oil tank, is provided, which collects the fluid from the circuit and out of which the second pump pumps the fluid into the first container by way of the cooling and/or filtering device. The term “separated” in this context means that the containers and/or their contents are kept entirely and fully separate from one another, with the result that fluid cannot flow from one container into the other and mix. For example, the containers may be arranged spatially separate from one another. Advantageously, in this way the contents of the containers cannot mix with one another even in the event of one of the containers overflowing. It is also possible for the containers to be arranged next to one another, provided the contents of the containers cannot mix with one another.

The “consumed” and/or hot fluid from the circuit is first collected in the second container. The dirt that is taken up by the fluid from the circuit and the consuming devices accumulates there. The fluid is then pumped into the first container using the second pump, via the cooling and/or filtering device. As a result of using the second pump, the possibility that the dirt from the first pump is drawn in again and put into the circuit and that this may lead to damage to consuming devices and/or components is advantageously prevented.

Further advantageously, using suitable measures the dirt can be extracted by the second container, which is separated from the first container, before the fluid is supplied to the cooling and/or filtering device, as a result of which advantageously there is more effective cooling and filtering by the cooling and/or filtering device, because less dirt can clog the cooling and/or filtering device. For example, first coarse dirt particles may be cohered by magnets, as a result of which the possibility that this dirt reaches the circuit is advantageously prevented. Further advantageously, using the second container the heated fluid from the return line of the pumps—for example “hot” leaked oil—is also accumulated centrally. As a result of the relatively great difference in temperature between fluid from the return line and the cooling medium of the cooling and/or filtering device, a greater cooling performance may be achieved, as a result of which efficiency is enhanced.

Over time, the fluid in the circuit takes up air. Further advantageously, the fluid in the second container has time to discharge again the air that has been taken up in the fluid. Because the dirt accumulates in the second container, substantially only clean, cooled and degassed fluid is made available to the first pump, which has a positive effect on the service life and efficiency of the first pump. Moreover, advantageously the first container may be given smaller dimensions, since the second container provides an overall larger volume for receiving the fluid. Further advantageously, as a result of separating the containers, the total space for the fluid may be made smaller because, as a result of the geometric arrangement of the containers, it is no longer possible for a blended temperature to arise, and, because the inflow of cooled and filtered fluid is as far away as possible from the first pump, despite the advantageously smaller volume the fluid still has enough time to be degassed and thus cavitation in the draw-in section of the first pump is prevented. The total container volume (in both containers) may thus advantageously be reduced by approximately 20% by comparison with a conventional configuration without separation.

Separation of the containers may preferably be performed such that the containers are arranged separately, locally spaced from one another. However, it is also possible for the containers to be arranged next to one another and/or received in a further container and separated from one another by a partition.

However, the first and/or the second container may also each have for example a volume that corresponds at least to the total volume of fluid used, with the result that advantageously at least one of the containers can receive the entire volume. This is advantageous for example if there is to be a complete change of fluid, since in this case only one container has to be emptied. Other volumes of containers are also fundamentally conceivable, however, such as a smaller volume, since typically the complete volume of fluid is not in a single container but is distributed over the containers and the circuit and the consuming devices.

In order advantageously to prevent fluid from overflowing from the first container and/or the second container, at least the second pump is controllable at least depending on the fluid collected in the second container from the circuit and/or depending on the filling level of the fluid in the first container. If for example more fluid is collected from the circuit by the second container than the amount of fluid the second pump can pump into the first container, it is possible to control the second pump accordingly. For example, the pumping output may be increased. Further, if for example the first container takes a form with a small volume, so that the filling level is too “high”, then likewise the second pump may be controlled such that fluid does not overflow from the first container, as a result of which advantageously dirtying is prevented and fluid is saved. Further, it is similarly possible, if for example the filling level in the first container lessens, for the second pump likewise to be controlled accordingly in that for example the pumping output is reduced. It is also possible for example for sensors to detect the filling level in the first and/or the second container and for the pumping output of the first and/or the second pump to be controlled accordingly. It is also conceivable for the first and/or the second pump to be controlled depending on the work step or part of the cycle of the machine. For example, during a rest condition of the machine, during which little fluid is required, the pumps may also be controlled accordingly, in that for example the pumping output is reduced or the pumps are switched off to save energy. Further advantageously, the controllability of the pumps also provides the constructional preconditions for the fluid to remain in the container, for example the first and/or the second container, for longer and thus to have more time for degassing.

Preferably, the second container and the first container are arranged fluidically in series. In this context, the term “fluidically” means that the arrangement of the containers is comparable for example with a series electrical circuit. For example, the fluid from the circuit, for example the working circuit, is collected in the second container and pumped from there into the first container by the second pump, which in turn pumps the fluid into the circuit. Advantageously, in this way the dirt in the fluid first accumulates in the second container before the fluid is pumped into the first container. The series circuit may be for example as follows: circuit (outlet)—second container—second pump—cooling and/or filtering device—first container—first pump—circuit (inlet).

It is also possible for the first pump to pump the fluid into the circuit by way of at least one further cooling and/or filtering device. Advantageously, in this way improved cooling performance is produced for the consuming devices, since the fluid is filtered and/or cooled an extra time. The series circuit may be for example as follows: circuit (outlet)—second container—second pump—cooling and/or filtering device—first container—first pump—further cooling and/or filtering device—circuit (inlet).

Likewise, a further cooling and/or filtering device may be arranged such that the fluid is first collected from the circuit by the second container by way of the further cooling and/or filtering device. The series circuit may be for example as follows: circuit (outlet)—further cooling and/or filtering device—second container—second pump—cooling and/or filtering device—first container—first pump—circuit (inlet).

The further cooling and/or filtering devices may also be combined with one another. The series circuit may be for example as follows: circuit (outlet)—further cooling and/or filtering device—second container—second pump—cooling and/or filtering device—first container—first pump—further cooling and/or filtering device—circuit (inlet).

Further preferably, at least the second pump may be controllable at least depending on the fluid collected in the second container from the circuit and/or depending on the filling level of the fluid in the first and/or the second container. Further preferably, the first pump may be controllable depending on the consuming devices and/or the required amount of fluid in the circuit. Optionally, it is also possible for the first and/or the second pump to be controlled depending on the conveying volume of the first and/or the second pump and/or the filling level of the first and/or the second container. If for example production of a consuming device cooled by the fluid or of a corresponding machine is increased, then it may be that the consuming device requires more fluid from the circuit in a relatively short period. In order to meet the requirement, the first pump may be controlled accordingly. It would then be necessary to control the second pump accordingly as well, since otherwise the first pump would not be able to pump any more fluid after a certain time, since not enough fluid would be pumped into the first container by the second pump.

For an advantageously compact configuration, preferably the first container and/or the second container are arranged in a machine base, such as a machine base for a machine for processing plasticizable materials, in particular an injection molding machine. It is for example also possible for the machine base to take a form that already has corresponding containers. The first and the second container may be arranged next to one another or indeed spatially separate from one another.

For an advantageously particularly compact and integrated configuration, the first container and the second container are parts of a third container and are separated from one another by at least one partition. For example, the third container may be provided for the purpose of collecting the fluid from the circuit. The fluid is collected at a particular location on the third container. The third container may be divided into two containers, or into the first and the second container, by a partition such as a dividing wall, a panel wall. For example, the machine base may serve as the third container, wherein the first and the second container are separated from one another by a dividing wall. It is also possible for the third container to have the first and the second container. The first and the second container may be integral constituent parts of the third container; for example, the third container may be made in at least one piece, wherein the third container xomprises at least one partition that divides the third container into the first and the second container.

In order advantageously to prevent fluid from overflowing from the first and/or the second container and thus “dirty” fluid from being pumped into the circuit, preferably the first and/or the second container may be configured to have a size such that overflow from the containers is prevented. For example, the first and/or the second container may have at least the total volume of the fluid used.

The fluid used may undergo a change in quality over time. In order advantageously to make recommendations for maintenance in the event of a deterioration in the quality of the fluid, preferably the first and/or the second container comprises at least one fluid sensor such as a particle sensor, a fluid condition sensor or an oil condition sensor. Advantageously, in this way important parameters regarding the state of the fluid may be monitored. Further, the fluid sensor may also detect the filling level of the fluid, for example in a container.

Preferably, the capacity of the first and/or the second pump takes its dimensions depending on the first and/or the second container. If for example the second pump pumps a large quantity of fluid from the second container into the first container and/or not very much fluid flows from the circuit into the second container, then the second container can be configured to be correspondingly small.

In order advantageously to obtain an automated control, preferably the second pump is controllable by open- and/or closed-loop control depending on at least one pump variable. The pump variable may for example adjust the output of the pump and further pump-specific parameters such as throughput, opening settings, and operating modes. For example, the pump variable may be determined on the basis of data from sensors and thus control the pump accordingly, by open-and/or closed-loop control.

Preferably, the pump variable is selected such that neither the first container nor the second container overflows or undergoes a shortfall. If for example the fluid filling level in the containers and/or the pumped fluid volume is/are detected, then the pump size may be selected accordingly such that there is no overflow from any of the containers, as a result of which dirtying by a fluid or fluid wastage are likewise prevented. Likewise, if for example the first pump has to make more fluid available to the circuit, the second pump may be controlled accordingly such that no shortfall occurs in the first container. Preferably, the pump controller knows the fluid volumes that occur and the current fluid filling level of the containers (for example how much fluid is flowing from the consuming devices back into the second container depending on the cycle progress, and how much fluid needs to be delivered to the circuit by the first pump), with the result that the controller can control output of the second pump in accordance with the current condition.

Further preferably, the pump variable depends on at least one of the following fluid volumes per unit time: a fluid volume that flows back into the second container from the circuit; a fluid volume that is pumped out of the second container and into the first container; a fluid volume that is pumped out of the first container and into the circuit. For example, it is possible to select the pump variable on the basis for example of the volume received by the containers per unit time and/or the fluid filling level using suitable sensors. If for example the filling level in the first container is high and only little fluid is collected in the second container from the circuit, then for example the pump variable may be controlled such that less fluid is pumped into the first container from the second container.

Preferably, the fluid inflow into the first and/or the second container is as far away as possible from the first and/or the second pump, as a result of which advantageously the fluid has time to discharge the air that is taken up and to be degassed. The term “as far away as possible” should be understood to mean that the fluid has to cover as long a path as possible between inflow into the container and drawing in by the corresponding pump, with the result that the fluid has enough time for degassing. It is for example possible for the path for the fluid between fluid inflow and fluid draw-in by the pump to be made longer by making the container larger. It is also possible for the pumps to be preferably controlled in order to control throughput accordingly. For example, the pump output may be reduced, so that the fluid remains in the container for longer and thus has more time for degassing. The constructional preconditions for this are determined by the controllable pumps.

Preferably, the first and/or the second container has at least one calming zone. Further preferably, the calming zone may have at least one obstacle such as a wall that forces the fluid onto a predetermined path. Advantageously, the fluid is thus given time to discharge the air that is taken up and to be degassed. For example, possible obstacles provided are vertical outlet panels, as a result of which the fluid is forced to climb up a panel and climb down a different panel, which advantageously favors degassing by way of air bubbles.

Further preferably, at least one calming zone in which the fluid is degassed is provided between the inflow of the fluid into the first and/or the second container and the first and/or the second pump. If the fluid flows for example into the first and/or the second container, then the calming zone in the first and/or the second container may be provided between inflow of the fluid and draw-in of the fluid by the second pump. For example, obstacles such as walls may be inserted in the container, and these guide the fluid and form a path as a calming zone and thus force the fluid onto as long a path as possible. Advantageously, the fluid is thus given more time to discharge the air that is taken up and to be degassed. For example, it is also possible for the fluid to have to cover a winding path, for example a meandering path, within the container. For example, an obstacle such as a panel may be secured at the base and a further obstacle such as a further transverse panel may be secured at the height of the upper fluid level. The fluid is thus forced to climb up the lower panel and to flow down the upper panel for example in a meandering shape, wherein advantageously the vertical faces of the obstacles additionally favor degassing, since the air bubbles are deposited on the walls of the panels and rise up. The calming zone is preferably in contact with the surroundings, with the result that sufficient exchange with the surroundings is ensured and the fluid can be degassed.

The disclosure provides also a method for filtering and cooling a fluid for a machine for processing plastics and plasticizable materials, in particular an injection molding machine, wherein at least one fluid is pumped out of a first container and into a circuit, and fluid is pumped into the first container by way of a cooling and/or filtering section. The fluid is collected from the circuit in a second container which is separated from the first container, and is pumped out of the second container and into the first container by way of the cooling and/or filtering section. Advantageously, all of the dirt from the circuit and the consuming devices accumulates in the second container, wherein the separation of the containers prevents the dirt from being drawn in again by the first pump. The dirt can be extracted from the second container by way of suitable measures before the fluid is supplied to the cooling and/or filtering section. The result is advantageously a higher degree of effectiveness and a longer service life for the cooling and/or filtering section.

Further advantageously, using the second container the heated fluid from the return line of the pumps, for example “hot” leaked oil, also accumulates centrally, wherein enhanced cooling performance and efficiency are achieved as a result of a relatively great difference in temperature between the returning fluid such as returning oil and the cooling medium.

Over time, the fluid in the circuit takes up air. Further advantageously, the fluid in the second container has time to discharge again the air that has been taken up in the fluid. Because the dirt accumulates in the second container, substantially only clean, cooled and degassed fluid is made available to the first pump, which advantageously has a positive effect on the service life and efficiency of the first pump.

Pumping the fluid from the second container into the first container is controlled depending on the fluid collected from the circuit in the second container, the fluid filling level in the first container and/or in the second container, and/or the fluid that is pumped into the circuit from the first container. Advantageously, in this way it is possible to respond to the most diverse changes in the circuit of the fluid; for example, if there is an increase in consumption in the circuit more fluid may be made available in the first container, assuming that there is enough fluid available in the second container. Further advantageously, the controllability of the pumps provides the preconditions for the fluid to be able to remain in the container for longer and thus to have more time for degassing. For example, the throughput through the pumps may be controlled such that the fluid remains in the container for longer and thus has more time for degassing.

Preferably, the second container and the first container are connected fluidically in series. In this context, the term “fluidically” means that the arrangement of the containers is comparable for example with a series electrical circuit. For example, the fluid from the circuit is collected in the second container and pumped from there into the first container by the second pump, which in turn pumps the fluid into the circuit. Advantageously, in this way the dirt in the fluid first accumulates in the second container. For example, first coarse dirt particles can be cohered by way of magnets before the fluid is pumped into the first container, which prevents this dirt from reaching the circuit. The important point is that the “dirty” fluid is guided by way of at least one filtering section before it is pumped into the circuit, for example the working circuit, by the first pump. In the circuit there may be for example closed-loop control components which respond sensitively even to the smallest amounts of dirt. Thus, the filtration serves both to improve the service life of the first pump but also to protect the sensitive control components. The series circuit may be for example as follows: circuit (outlet)—second container—second pump—cooling and/or filtering device—first container—first pump—circuit (inlet).

In order advantageously to prevent dirtying by fluid or wastage of fluid, at least as much fluid is pumped from the second into the first container as reaches the second container from the circuit. For example, on average at each operating point more fluid is removed from the second container than flows out of the circuit back into the second container. Advantageously, in this way an even flow of fluid is ensured, with the result that a consistent cooling action is achieved. Thus, it is further advantageously ensured that the second container does not overflow, as a result of which dirtying by fluid and/or wastage of fluid is prevented.

Preferably, the second pump is controlled such that the second pump pumps at least as much fluid from the second into the first container as reaches the second container from the circuit. For example, the more evenly the fluid is transferred from the second container into the first container, the smaller the volume of the containers, in particular the first container, may be and the more the total quantity of fluid required may be reduced, which advantageously saves on resources.

Preferably, pumping the fluid from the second container into the first container is controlled depending on at least one pump variable. The pump variable may be the result of a plurality of data and/or information points, for example from sensors. For example, the pump variable may be the result of the filling level of the containers, the throughput through the pumps, and the fluid material.

Advantageously for preventing dirt as a result of overflowing fluid, preferably the pump variable is selected such that no fluid flows out of the first container into the second container. If for example the containers are located close by one another, or the containers are separated by a wall, “dirty” fluid from the second container may flow into the first container uncooled and unfiltered.

Preferably, the fluid in the first and/or the second container is constrained onto at least one path relating to at least one calming zone. Advantageously, the fluid remains in the first and/or the second container for longer and thus has more time for degassing.

Further preferably, for advantageously enhanced effectiveness, the fluid remains in the first and/or the second container at least until the air taken up in the fluid has been discharged. The fluid is given a certain time in the first and/or the second container in order to discharge the air that has been taken up in the fluid over time. For example, by way of controlling the first and/or the second pump, the fluid may be caused to remain in the container for a relatively long period by for example reducing the pump output. It is also possible for the flow rate of the fluid to be changed and/or the distance covered by the fluid from its inflow into the first and/or the second container until it reaches the first and/or the second pump to be changed, preferably being increased.

The disclosure provides likewise a machine for processing plastics and other plasticizable materials, in particular an injection molding machine, wherein the machine has at least one above-described fluid cooling/filtering arrangement and/or takes a form, is configured and/or is set up to carry out at least an above-described method.

Further advantages are apparent from the subclaims and the description below of a preferred exemplary embodiment. The features listed individually in the claims are combinable, where this is technologically meaningful, and may be supplemented by explanatory information from the description and details from the Figures, further variant embodiments of the disclosure being pointed out.

### BRIEF DESCRIPTION OF THE FIGURES

The disclosure is explained in more detail below with reference to an exemplary embodiment represented in the attached Figures, in which:

FIG. 1 shows a cooling/filtering arrangement,

FIGS. 2-5 show schematic, isometric views of a cooling/filtering arrangement,

FIG. 6 shows a schematic, isometric view of a cooling/filtering arrangement with the fluid flow indicated,

FIG. 7 shows a schematic (fluid-flow) view of a cooling/filtering arrangement,

FIGS. 8a-d each show a schematic illustration of a container arrangement,

FIG. 9 shows a cooling/filtering arrangement with a calming zone, and

FIG. 10 shows a cooling/filtering arrangement with a calming zone.

### DETAILED DESCRIPTION

The disclosure is now explained in more detail by way of example, with reference to the attached drawings. However, the exemplary embodiments are only examples, which are not intended to restrict the inventive concept to a particular arrangement.

Before the disclosure is described in detail it should be pointed out that it is not restricted to the respective structural parts of the device and the respective method steps, since these structural parts and method may vary. The terms used here are merely intended to describe particular embodiments and are not used restrictively. Moreover, where the singular or the indefinite article is used in the description or the claims, this also refers to a plurality of these elements unless the overall context unambiguously indicates otherwise.

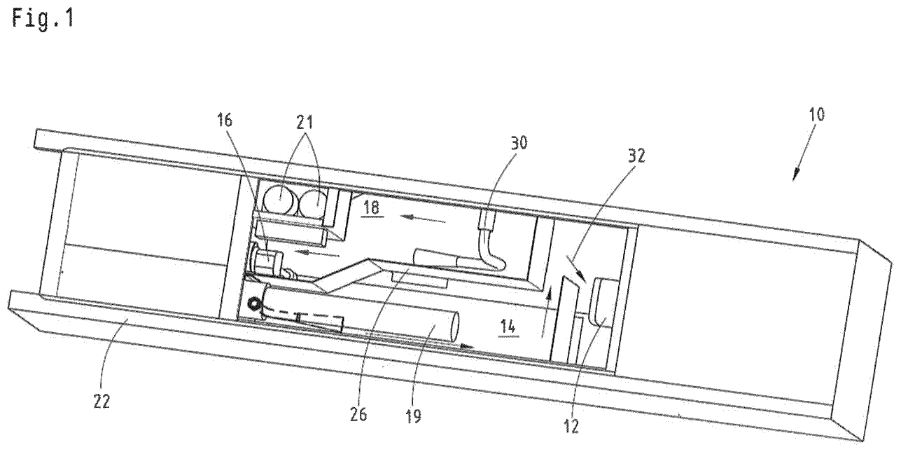

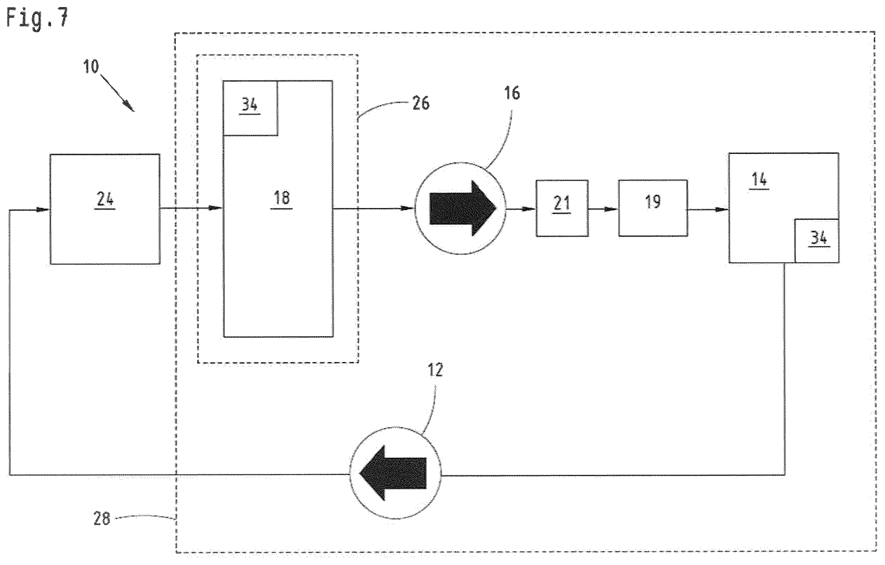

In FIG. 1, an exemplary embodiment shows a cooling/filtering arrangement 10 for a machine for processing plastics and other plasticizable materials, in particular an injection molding machine, having a first pump 12, which is configured for pumping at least one fluid from a first container 14 into a circuit 24, and a second pump 16, which is configured for pumping the fluid into the first container 14 by way of at least one cooling device 19 and/or filtering device 21. The first container 14 and the second container 18 are completely separated from one another in FIG. 1 by way of a partition 26 such as a wall. The fluid is pumped out of the second container 18 and into the first container 14 by the second pump 16 by way of the cooling device 19 and/or filtering device 21. In a further exemplary embodiment, the first container 14 and the second container 18 may be at least part of a third container 28, as also illustrated schematically in FIG. 7. Further, the first pump 12 and the second pump 14 and the cooling device 19 and/or filtering device 21 may also be arranged in the third container 28, which is itself arranged for example in a machine base 22. In FIG. 1, fluid from the circuit 24 comes out of hoses 30 and is collected in the second container 18. The fluid flows for example in the direction of the arrows 32 in the second container 18 to the second pump 16, or is drawn in by the second pump 16. The second pump 16 pumps the fluid into the first container 14 by way of the cooling device 19 and/or filtering device 21, and from there it is pumped into the circuit 24 by the first pump 12.

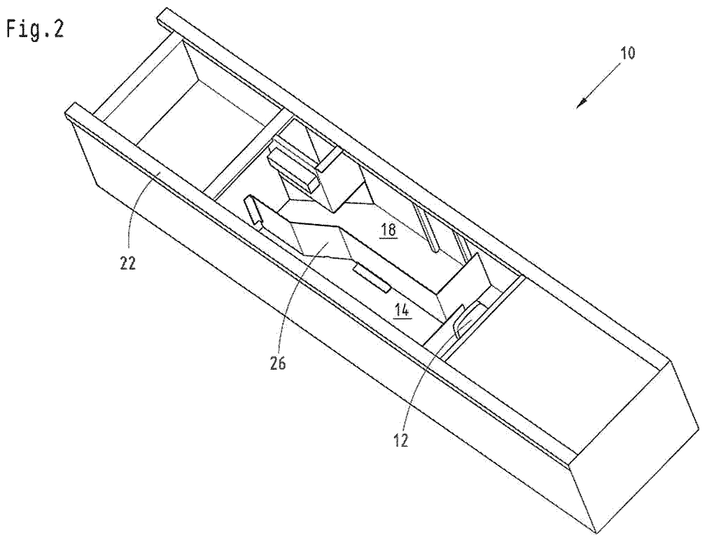

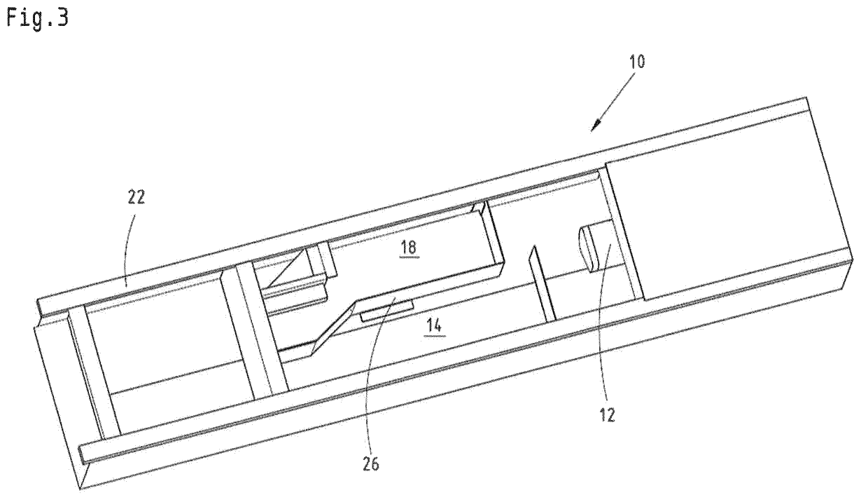

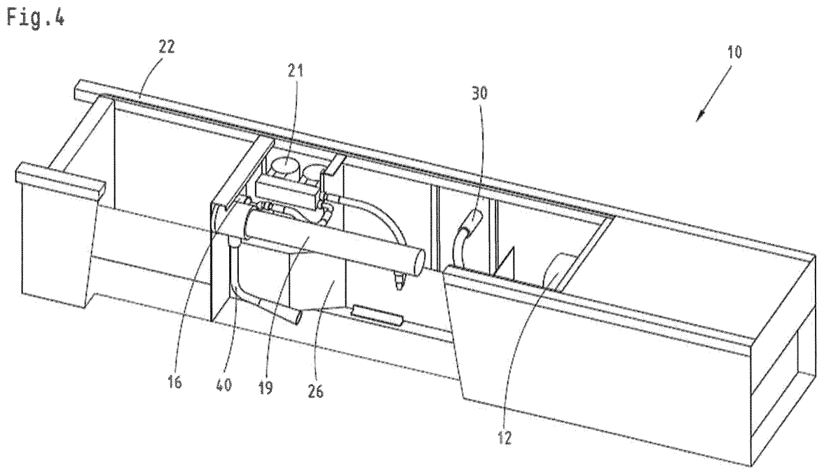

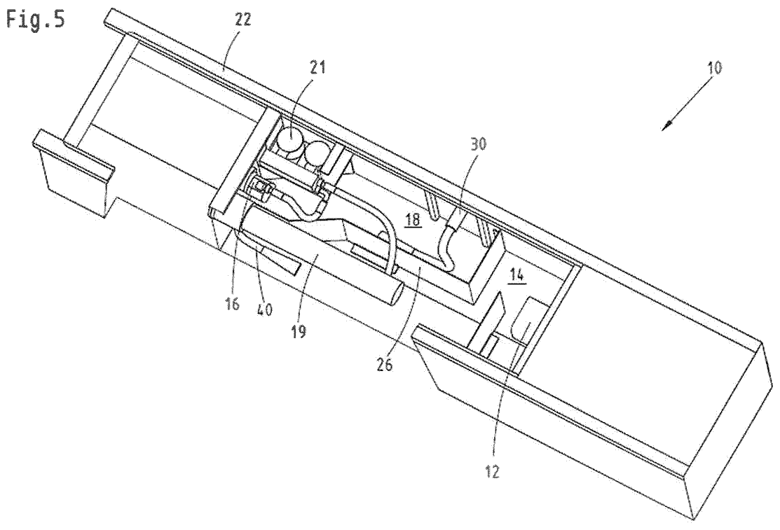

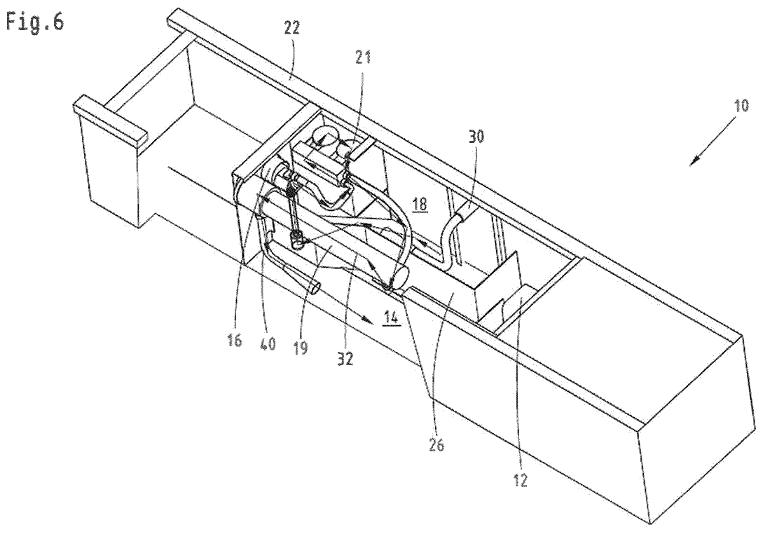

FIGS. 2-6 each show further exemplary embodiments of a schematically and isometrically illustrated cooling/filtering arrangement 10 from different perspectives, wherein a part of a wall of the machine base 22 has been cut away in each case from FIGS. 4 and 5 for the purpose of clarity. In FIG. 6, the fluid flow is indicated by arrows 32. In the exemplary embodiment of FIG. 6, the fluid comes first from the circuit 24 by way of a hose 30 and into the second container 18. From there, the fluid is pumped by the second pump 16, first by way of the filtering device 21, and by way of the cooling device 19 into the first container 14. From there, it is pumped into the circuit 24 by the first pump 12.

FIG. 7 shows a further exemplary embodiment and a schematic (fluid-flow) illustration of the cooling/filtering arrangement 10. The first container 14 and the second container 18 are arranged fluidically in series. The fluid is first collected from the circuit 24 by the second container 18 and then pumped, by way of the cooling device 19 and/or filtering device 21, by the second pump 16 into the first container 14, from where it is pumped into the circuit 24 by the first pump 12.

In the exemplary embodiment of FIG. 1, at least the second pump 16 is controllable at least depending on the fluid collected from the circuit 24 in the second container 18 and/or depending on the filling level of the fluid in the first container 14. For example, this may be done by way of a controller (not illustrated) and/or by way of a machine controller.

For an advantageous compact configuration, in a further exemplary embodiment according to FIG. 1 the first container 14 and/or the second container 18 are arranged in a machine base 22, for example in a machine base of a machine for processing plasticizable materials, in particular an injection molding machine.

In a further exemplary embodiment in FIG. 7, the first container 14 and the second container 18 are parts of a third container 28 and are separated from one another by at least one partition 26. In a further preferred exemplary embodiment according to FIG. 1, the third container 28 may be arranged in a machine base 22 or be part of the machine base 22. In FIG. 1, the machine base 22 so to speak forms the third container 28, while the partition 26, such as a wall, divides the third container into the first container 14 and the second container 18. However, it is also possible for the machine base 22 to have the first container 14 and the second container 18 or to take a corresponding form.

In order to enable monitoring of the fluid in a manner advantageous for better quality, in a further exemplary embodiment according to FIG. 7 the first container 14 and/or the second container 18 has/have at least one fluid sensor 34.

In a further exemplary embodiment according to FIG. 1, at least the second pump 16 is controllable by open-and/or closed-loop control depending on at least one pump variable. For example, depending on fluid returning out of the circuit 24, it is possible by way of the pump variable to set the second pump 16 to pump more or less fluid out of the second container 18 and into the first container 14. In a further exemplary embodiment, the pump variable is preferably selected such that neither the first container 14 nor the second container 18 overflows or undergoes a shortfall.

In a further exemplary embodiment, the pump variable depends on at least one of the following fluid volumes per unit time:
a fluid volume that flows back into the second container 18 from the circuit 24;
a fluid volume that is pumped out of the second container 18 and into the first container 14;
a fluid volume that is pumped out of the first container 14 and into the circuit 24.

In an exemplary embodiment according to FIG. 7, a method for filtering and cooling a fluid for a machine for processing plastics and plasticizable materials, in particular an injection molding machine, is illustrated, wherein at least one fluid is pumped out of a first container 14 into a circuit 24 and fluid is pumped into the first container 14 by way of a cooling device 19 and/or filtering device 21. The fluid from the circuit 24 is collected in a second container 18 which is separated from the first container 14, and is pumped out of the second container 18 and into the first container 14 by way of the cooling 19 and/or filtering device 21.

In a further exemplary embodiment according to FIG. 7, the second container 18 and the first container 14 are connected fluidically in series.

In the exemplary embodiment of FIG. 7, pumping of the fluid from the second container 18 into the first container 14 is controlled depending on the fluid that is collected in the second container 14 from the circuit 24, the fluid filling level in the first container 14 and/or the second container 18, and/or the fluid that is pumped into the circuit 24 from the first container 14.

In a further exemplary embodiment according to FIG. 7, at least as much fluid is pumped from the second container 18 into the first container 14 as reaches the second container 18 from the circuit 24.

In a further exemplary embodiment according to FIG. 7, the second pump 16 is controlled such that at least as much fluid is pumped from the second container 18 into the first container 14 as reaches the second container 18 from the circuit 24.

In a further exemplary embodiment according to FIG. 7, pumping of the fluid from the second container 18 into the first container 14 is controlled depending on at least one pump variable.

In a further exemplary embodiment according to FIG. 1, the pump variable is selected such that no fluid flows out of the first container 14 into the second container 18.\hat{ }

In order advantageously to prevent “dirty” fluid from being pumped into the circuit 24, in a further preferred exemplary embodiment the first container 14 and/or the second container 18 may be selected or configured to have a size or volume such that the containers 14, 18 are prevented from overflowing. For example, the containers 14, 18 may take a form that is at least as large as the total volume of fluid used.

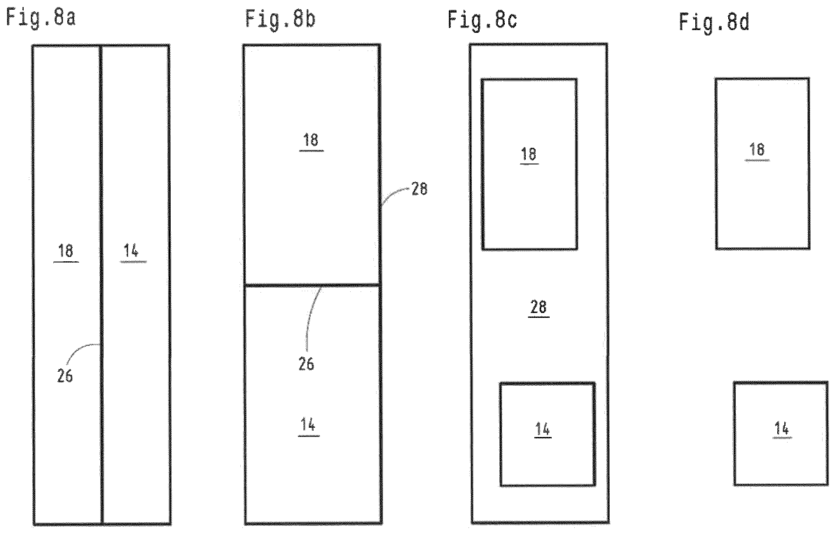

FIGS. 8a-8d each illustrate further preferred exemplary embodiments that show how the containers 14, 18 and 28 are arranged in relation to one another.

In FIG. 8a, the first container 14 and the second container 18 are arranged next to one another and are separated from one another by a partition 26 such as a wall. For example, the containers 14, 18 may be pushed together such that their walls are in physical contact and thus form the partition 26. However, it is also possible to provide an additional partition 26.

In FIG. 8b, the first container 14 and the second container 18 are each parts of the third container 28 and are separated from one another by a partition 26. Generally, it is also conceivable for the first container 14 and the second container 18 together to form the third container 28 and to be separated from one another by a partition 26. It is also conceivable for the third container 28 to form the first container 14 and the second container 18 as a result of the partition 26.

In FIG. 8c, the first container 14 and the second container 18 are parts of the third container 28, wherein the first container 14 and the second container 18 are arranged such that they are spatially separated from one another and so no partition 26 is required. For example, the containers 14, 18 may be arranged in the third container 28 without their walls being in physical contact. Advantageously, in this way there is no mixing of the respective contents even in the event of a container 14, 18 overflowing. It is thus also advantageous that in the event of one of the container 14, 18 overflowing the overflow accumulates in the third container 28.

In FIG. 8d, the first container 14 and the second container 18 are arranged spatially separated from one another such that likewise no partition 26 is required. Advantageously, there is no mixing of the respective contents in the event of one of the containers 14, 18 overflowing.

In a further preferred exemplary embodiment according to FIG. 4, the fluid inflow into the first container 14 and/or the second container 18 is as far away as possible from the first pump 12 and/or the second pump 16. For example, in FIG. 4 the fluid flows into the first container 14 at “bottom left” out of a hose 40, and is pumped on by the first pump 12 at “top right”. It will be appreciated that, depending on the configuration of the containers, the location of fluid inflow and the location of pumping it on may differ.

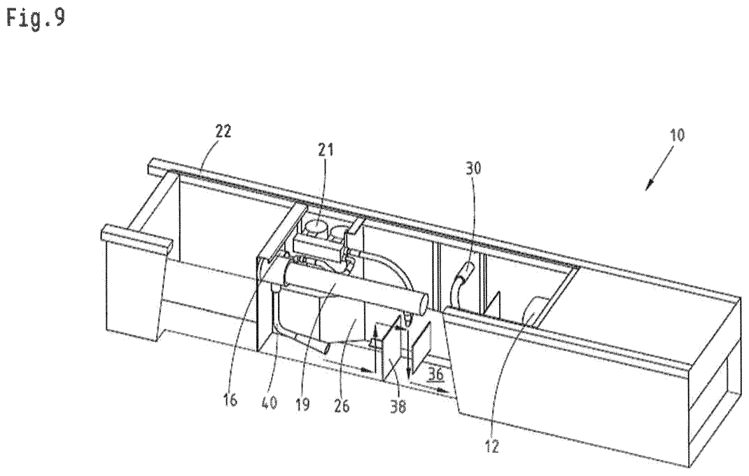

In a further preferred exemplary embodiment according to FIG. 9, an obstacle 38 such as a panel is secured at the base and a further obstacle 38 such as a further transverse panel is secured at the height of the upper fluid level in the first container 14. In FIG. 9, fluid flow is illustrated by arrows. The fluid is thus forced to climb up the lower panel and to flow down the upper panel, wherein advantageously the vertical faces of the obstacles additionally favor degassing, since the air bubbles are deposited on the walls of the panels and rise up. Principally, any number of obstacles 38 may be provided, depending on the space in the container. Fundamentally, it is also possible for the second container 18, or the first container 14 and the second container 18, to have a calming zone 36. It is also possible for a plurality of calming zones 36 to be provided in the first container 14 and/or second container.

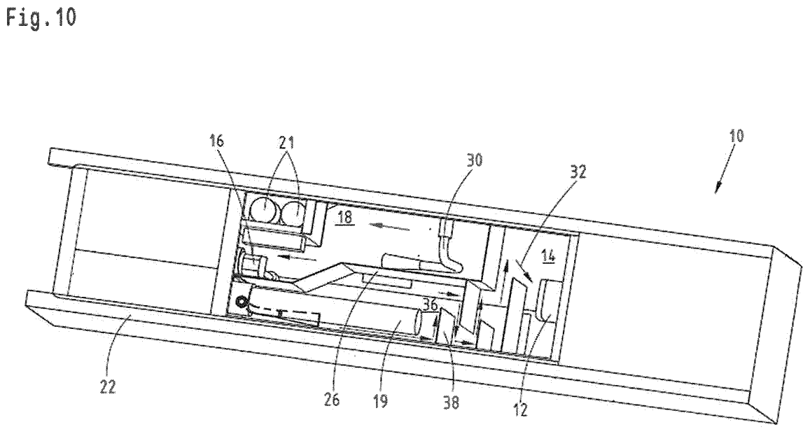

In a further preferred exemplary embodiment according to FIG. 10, the first container 14 has a calming zone 36 which has three obstacles 38 such as walls. Fundamentally, however, any number of obstacles 38 may be provided. The fluid is thus forced onto a relatively long path, for example in a meandering shape, such that the fluid is given more time for degassing. Fundamentally, it is also possible for the second container 18, or the first container 14 and the second container 18, to have a calming zone 36. It is also possible for a plurality of calming zones 36 to be provided in the first container 14 and/or second container.

In a further preferred exemplary embodiment, the exemplary embodiments according to FIG. 9 and FIG. 10 may also be combined with one another. The fluid is thus constrained by obstacles 38 such as panels at the base and transverse panels to climb up the lower panel and to flow down the upper panel, wherein the fluid is at the same time constrained onto a winding path.

In a further preferred exemplary embodiment according to FIG. 10, provided between fluid inflow into the first container 14 and/or the second container 18 and the first pump 12 and/or the second pump 16 is at least one calming zone 36 in which the fluid is degassed.

It goes without saying that this description may be subject to the most diverse modifications, changes and adaptations which are within the range of equivalents to the attached claims.

1. A fluid cooling/filtering arrangement, configured for a machine for processing plastics and other plasticizable materials, comprising
a first pump configured for pumping a fluid out of a first container into a circuit, and
a second pump configured for pumping the fluid into the first container by way of at least one of a cooling device and a filtering device,
a second container separated from the first container which collects the fluid from the circuit and out of which the second pump pumps the fluid into the first container by way of the at least one cooling device and the filtering device,
wherein the second pump is controllable at least depending on at least one of the fluid collected in the second container from the circuit and/or depending on the filling level of the fluid in at least one of the first container and the second container,
wherein the first container or the second container comprises a calming zone and the calming zone comprises an obstacle that forces the fluid onto a predetermined path.

2. The arrangement as claimed in claim 1, wherein the second container and the first container are arranged fluidically in series.

3. The arrangement as claimed in claims 1, wherein at least one of the first container and the second container are arranged in a machine base.

4. The arrangement as claimed in claim 1, wherein the first container and the second container are parts of a third container and are separated from one another by a partition.

5. The arrangement as claimed in claim 1, wherein at least one of the first container and the second container comprise at least one fluid sensor.

6. The arrangement as claimed claim 1, wherein the second pump is controllable by at least one of an open-loop control and a closed-loop control depending on at least one pump variable.

7. The arrangement as claimed in claim 6, wherein the pump variable is selected such that neither the first container nor the second container can overflow or undergo a shortfall.

8. The arrangement as claimed in claim 6, wherein the pump variable depends on at least one of the following fluid volumes per unit time:
a fluid volume that flows back into the second container from the circuit;
a fluid volume that is pumped out of the second container and into the first container;
a fluid volume that is pumped out of the first container and into the circuit.

9. The arrangement as claimed in claim 1, wherein a fluid inflow into at least one of the first container or the at least one second container is as far away as possible from the first pump or the second pump.

10. (canceled)

11. The arrangement as claimed in claim 1, wherein the calming zone is provided between at least one of an inflow of the fluid into the first container and the first pump and an inflow of the fluid into at least one of the second container and the second pump.

12. A method for filtering and cooling a fluid for a machine for processing plastics and other plasticizable materials, the method comprising:
pumping out of a first container and into a circuit, and
pumping fluid into the first container by way of at least one of a cooling device and a filtering device,
wherein the fluid is collected from the circuit in a second container which is separated from the first container,
wherein the fluid is pumped out of the second container and into the first container by way of the at least one cooling device and the filtering device,
wherein pumping the fluid from the second container into the first container is controlled depending on at least one of the fluid collected from the circuit in the second container, the fluid filling level in the at least one first container and the second container, and/or the fluid that is pumped into the circuit from the first container,
wherein the fluid in the at least one container and the second container is forced on a path in respect of a calming zone, and
wherein the calming zone comprises an obstacle that forces the fluid onto the path.

13. The method as claimed in claim 12, wherein the second container and the first container are connected fluidically in series.

14. The method as claimed in claim 12, wherein at least as much fluid is pumped from the second container into the first container as reaches the second container from the circuit.

15. The method as claimed claim 12, wherein pumping the fluid from the second container into the first container is controlled depending on at least one pump variable.

16. The method as claimed in claim 15, wherein the pump variable is selected such that no fluid flows out of the first container into the second container.

17. (canceled)

18. The method as claimed claim 12, wherein the fluid remains in the at least one first container and the second container at least until the air taken up in the fluid has been discharged.

19. A machine for processing plastics and other plasticizable materials, wherein the machine comprises a fluid cooling/filtering arrangement as claimed in claim 1.

20. A machine for processing plastics and other plasticizable materials, wherein the machine is configured for carrying out a method as claimed in claim 11.
